(19) United States
(12) Patent Application Publication
(10) Pub. No.: US 2012/0227028 A1
(43) Pub. Date: Sep. 6, 2012

(54) GRAPHICAL PROGRAMMING OBJECT POPULATION USER INTERFACE AUTOGENERATION

(75) Inventors: (Lawrence) Iek Hoi Pun, Shanghai (CN); Yun Jin, Issaquah, WA (US); Guang Yang, Shanghai (CN); Ping Song, Shanghai (CN)

(73) Assignee: Microsoft Corporation, Redmond, WA (US)

(21) Appl. No.: 13/040,194

(22) Filed: Mar. 3, 2011

(51) Int. Cl. G06F 9/44

(52) U.S. Cl. 717/108

(57) ABSTRACT

Automatically generated user interfaces are provided to aid data population of object instances in graphical programming environments. A selection gesture identifies an instance of an object type. The public fields defined for the instance are automatically determined, and a user interface is automatically generated with the name of each defined field and a currently assigned value for each field that has one. Fields which have no currently assigned value are optionally displayed with a hint. The user interface can be placed in an application under development, such as a sequential workflow application, as a class initializer and/or as an object configurator. When the object to be populated has another object as a field, the fields of that nested object are similarly displayed. Data can be entered into a container object through the user interface without replacing prior value(s) of the container object.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Some programming languages allow developers to manipulate portions of a program graphically instead of (or in addition to) allowing textual manipulation of program code. For example, an intrinsically visual programming language (VPL) lets developers create programs by manipulating parts of a program graphically instead of specifying them textually. A VPL may allow programming with visual expressions, such as by making spatial arrangements of text and graphic symbols. Some VPLs use on-screen boxes connected by arrows or lines that represent relationships. A non-visual language can be treated similarly, by superimposing a visual representation. Visual programming is sometimes referred to as graphical programming, dataflow programming, or diagrammatic programming.

Independently of whether an intrinsically visual programming language is used, a given program development environment may also support visual programming. Environments which support visual programming may also be referred to as graphical programming environments. Like other development environments, graphical programming environments may be tightly integrated or more loosely organized. That is, graphical manipulation of program contents may be available as part of an integrated development environment, or as part of a software development environment whose components are not necessarily integrated into a single programming tool.

### SUMMARY

In some familiar graphical programming environments, it is difficult to rapidly initialize an instance of an object of arbitrary type with multiple pieces of data or to configure an existing object instance with the data. Such environments only allow developers to populate the data into the object instance one field at a time.

However, some embodiments described herein facilitate data population of object instances in graphical programming environments. Data population may occur during initialization when an object instance is first created and/or during configuration of previously created and utilized object instances. A given instance of an object type in the graphical programming environment has field(s) (a.k.a. properties) which are defined by the object type. Each field of the instance has a name and is capable of being assigned a value. Object instances are sometimes referred to simply as objects.

From a tool's perspective, some embodiments receive a selection (e.g., mouse-click or other user gesture) that identifies the instance of the object type. The fields defined for the selected object type instance are automatically determined, and an instance data population user interface is automatically generated in the graphical programming environment. The user interface displays the name of each field that is defined for the object type instance, and displays a currently assigned value for each field that currently has an assigned value. In some embodiments, the user interface also optionally displays fields of the instance which have no currently assigned value, together with a visual indication to that effect, e.g., “click to edit”, “enter an expression”, a question mark, an empty box, or another indication that no value has been assigned.

The instance data population user interface can be used in an application under development, such as a sequential workflow application or another workflow application which is being edited in a graphical programming environment, for example. The user interface may be placed in the application as a class initializer for a class that is defined with the object type, and/or placed as an object configurator for an existing object which is defined with the object type. Either placement permits developers to populate the data into multiple object instance fields with a single operation.

In some embodiments, when the object to be populated has another object as a field, the fields of that nested object are similarly displayed; this may be done to a specified nesting depth, or may be implemented only for second-level objects. Private (non-public) fields of an object are hidden in some embodiments, since they are not available to be populated from outside the instance; other embodiments show private fields but do not accept values to be assigned to them. Some embodiments permit read-only public fields. Some embodiments accept data into a container object through the instance data population user interface, without replacing prior value(s) which were present in the container object.

From a developer's perspective, some embodiments allow a developer to populate an object instance with data by locating the instance in a graphical programming environment, and making an instance selection gesture which indicates selection of the instance. In response, graphical programming object population user interface autogeneration code automatically generates a data population user interface for viewing and use by the developer. The developer can then enter data to populate the object, and can insert the user interface in an application which is the developer is editing in the graphical programming environment.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, a graphical programming environment for developing applications, and other items in an operating environment which may be present on multiple network nodes, and also illustrating configured storage medium embodiments;

FIG. 2 is a block diagram illustrating aspects of graphical programming object population user interface autogeneration in an example architecture;

FIG. 3 is a flow chart illustrating steps of some process and configured storage medium embodiments;

FIG. 4 is a simplified screenshot illustrating an initializer data population user interface according to some embodiments, with unassigned fields displayed and with one data entry made;

FIG. 5 shows the user interface of FIG. 4 after additional data entries have been made, and also shows fields of a nested object; and

FIG. 6 is a simplified screenshot illustrating a data population user interface placed in a sequential workflow application according to some embodiments.

### DETAILED DESCRIPTION

### Overview

Some familiar graphical programming environments only allow developers to populate data into an object instance one field at a time. This constraint leads to a suboptimal developing experience, as it is time consuming and may cause the screen to become cluttered with user interface elements representing the data population.

By contrast, some embodiments described herein generate a user interface in a graphical programming environment to let a developer conveniently enter data into an object to initialize and/or otherwise configure the object. The user interface is based on the metadata of the object type. Such autogeneration of a helpful user interface saves the developer from going through the metadata manually, and avoids duplicated effort otherwise involved in populating data into multiple objects of the same type. Thus, autogeneration of a data population user interface can improve productivity and reduce mistakes.

Without such assistance, a developer who wants to initialize an object with several pieces of data may have only options such as (i) programming a custom user interface for initializing different type of objects, or (ii) programming a generic component for assigning a value to a variable (L-value), and using it multiple times on every field of an object that needs data initialization. Either option could be time-consuming. The second option is also unsuitable for adding values to a collection, and is highly repetitive because it involves having the developer recall the names of the fields of the object and configure the generic component manually for every object created. If any of the data to be populated is, in turn, another object (namely a second-level object) requiring data population, the developer faces also repeating such steps for that nested object. Such an approach is not only tedious but also error-prone.

By contrast, embodiments described herein can simplify development by automatically generating a user interface from the object metadata, so that the developer does not have to remember or type in the names of the fields of the object. In some embodiments, the developer selects an object type, and then a user interface is generated based on the fields defined for that object; the field information is extracted from object metadata of the object type of the selected object (or object type). The developer still enters the data to be populated into the object, but the names of the fields have been automatically generated.

In some embodiments, only public fields are exposed when generating the fields from object metadata. Non-public fields (private fields) are meant to be used within the object only and are not exposed to the developer.

In some embodiments, if any of the fields is itself an object, an option is provided to let the developer populate data into that object directly. For example, consider a Customer object with an Address field. With some embodiments, the developer can enter the street name into the Address field as part of the initialization process of the Customer object, without having to create and initialize an Address object in advance. This option may be disabled for primitive types, such as int, string, bool, etc.

In some embodiments, when the object is a common container type, such as Collections and Dictionaries in Microsoft®.Net Framework, the embodiment generates a user interface to let the developer insert data into the container but does not replace the container object. In some cases a developer may also delete, modify, and/or reorder container contents.

Some embodiments described herein may be viewed in a broader context. For instance, concepts such as initialization, configuration, data entry, user interaction, and graphical programming may be relevant to a particular embodiment. However, it does not follow from the availability of a broad context that exclusive rights are being sought herein for abstract ideas; they are not. Rather, the present disclosure is focused on providing appropriately specific embodiments. Other media, systems, and processes involving initialization, configuration, data entry, user interaction, and graphical programming are outside the present scope. Accordingly, vagueness and accompanying proof problems are also avoided under a proper understanding of the present disclosure.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

“Code” means processor instructions, data (which includes constants, variables, and data structures), or both instructions and data.

“Program” is used broadly herein, to include applications, kernels, drivers, interrupt handlers, libraries, and other code written by programmers (who are also referred to as developers).

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine. However, “automatically” does not necessarily mean “immediately”.

Throughout this document, use of the optional plural “(s)” means that one or more of the indicated feature is present. For example, “field(s)” means “one or more fields” or equivalently “at least one field”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as “accessing”, “locating”, “viewing”, “selecting”, “editing”, “deriving”, “displaying”, “collecting”, “transmitting”, “sending”, “receiving”, “displaying”, “issuing”, or “communicating” with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile, memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by data population user interface autogeneration as discussed herein, e.g., by binding, deployment, execution, modification, display, creation, loading, and/or other operations.

A graphical programming environment 120, applications 122 developed through the environment, object types 124 used in the applications, other software, and other items shown in the Figures and/or discussed in the text may reside partially or entirely within one or more media 112, thereby configuring those media. Object types may be instantiated in memory as instances 126, which have fields 128 (sometimes also called properties herein). Fields generally include private fields 130 and public fields 132. Fields 128 have names 134 and are capable of holding assigned values 136. In addition to processor(s) 110 and memory 112, an operating environment may also include other hardware, such as display(s) 138, buses, power supplies, and accelerators, for instance.

A given operating environment 100 may include an Integrated Development Environment (IDE) 140 which provides a developer with a set of coordinated software development tools. In particular, some of the suitable operating environments for some embodiments include or help create a Microsoft® Visual Studio® development environment (marks of Microsoft Corporation) configured to support program development, in some cases using a graphical programming environment. Some suitable operating environments include or support familiar programming languages such as the Visual Basic®, Visual C++®, or Visual C#® languages (marks of Microsoft Corporation), but teachings herein are applicable with a wide variety of programming languages, programming models, and programs.

One or more items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

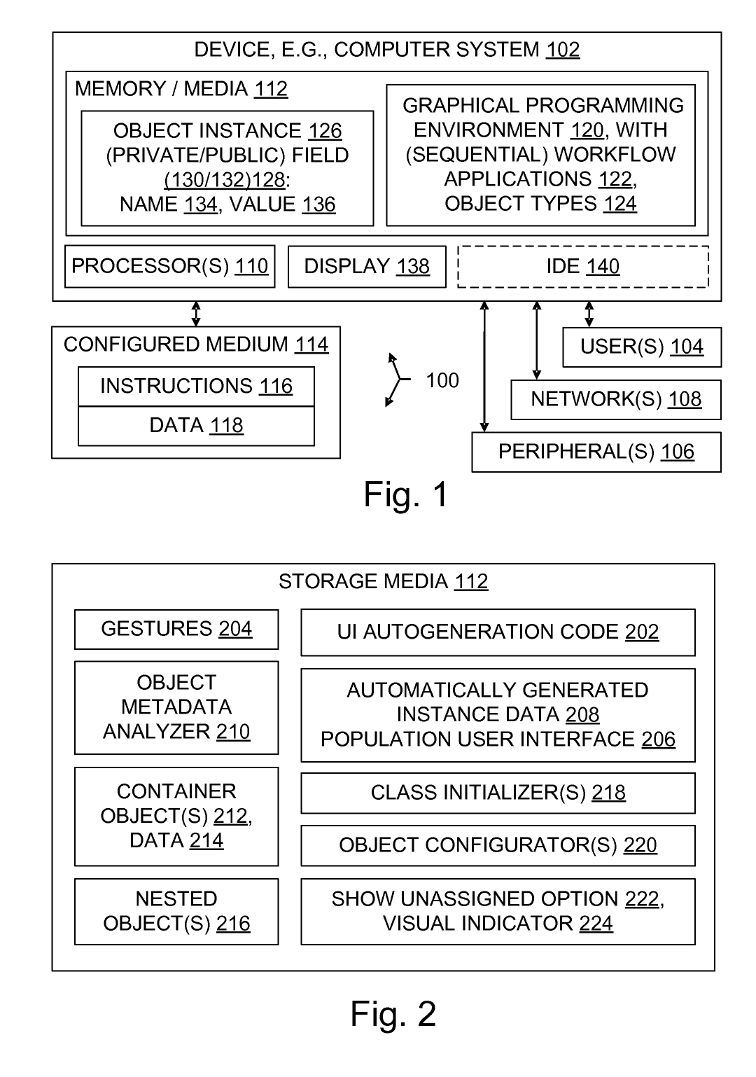

FIG. 2 illustrates an architecture which is suitable for use with some embodiments. User interface (UI) autogeneration code 202 responds to user gestures 204 by generating user interfaces 206 to facilitate populating object instances 126 with data 208 in an enhancement to a graphical programming environment 120. The UI autogeneration code 202 may include a metadata analyzer 210, or code 202 may invoke a separate metadata analyzer 210. Object types 124, such as Microsoft® Common Language Runtime or other types 124, are input to the object metadata analyzer 210, which uses familiar techniques to then output information such as field names 134, whether objects are container objects 212 (possibly with existing data 214), and whether objects have second-level objects or other nested objects 216. Object field values 136 may also be provided to (or extracted by) the UI autogeneration code 202.

Autogeneration code 202 uses the field information and familiar UI components (text boxes, windows, etc.) to generate data population user interfaces 206, for placement in applications 122 as class initializers 218 and/or object configurators 220. Some embodiments generate different user interfaces 206 for primitive types, for non-primitive object types, and for container types. Some embodiments include an option 222 to show unassigned fields (fields having not current assigned value 136), using a visual indicator 224 in the user interface 206.

With reference to FIGS. 1 and 2, some embodiments provide a computer system 102 with a logical processor 110 and a memory medium 112 configured by circuitry, firmware, and/or software to transform an application under development by extending user interface functionality with automatically generated data population interfaces 206 as described herein.

In some embodiments, a computer system 102 includes a logical processor 110, a memory 112 in operable communication with the logical processor, and a graphical programming environment 120 residing in the memory. The graphical programming environment 120 has an instance 126 of an object type 124. The instance has at least one field 128 defined by the object type, with each field 128 of the instance 126 having a name 134 and capable of being assigned a value 136. The system 102 also includes a display 138. An automatically generated instance data population user interface 206 configures the display 138, with at least the following: the name 134 of each field 128 that is defined for the object type instance, and a currently assigned value 136 for each field 128 that currently has an assigned value.

In some embodiments, the display 138 is further configured by a field 128 of the object type instance which has no currently assigned value, together with a visual indication 224 that the field has no currently assigned value.

In some embodiments, a field F of the instance is a nested object 216, namely, an object with fields of its own. The display 138 is configured by the name(s) of field(s) 128 that are defined for the field F object, and may also be configured by currently assigned value(s) of field(s) of the field F nested object.

In some embodiments, the instance 126 has at least one field that is defined as a private field 130, and the automatically generated instance data population user interface 206 configuring the display 138 does not show that private field 130. In some embodiments, a public field 132 of an object is defined as read-only with regard to accesses from outside that object, and the current value (if any) of the field is displayed but cannot be changed using the automatically generated interface 206. More generally, in some embodiments a field 128 may have a current value or not, may be editable through the interface 206 or not (i.e., read-only), may be displayed or not, and may be private or not (i.e., public), although some combinations (e.g., editable private fields) may be unsupported.

In some embodiments, the instance 126 is a container object 212, and the system 102 includes both (i) first data 214 which appears in the container without being present in the instance data population user interface 206, and (ii) later data 118 which appears in the container object 212 and which also appeared in the instance data population user interface 206. The later data 118 is entered into the container object 212 through the user interface 206 without replacing the first data 214 which was previously present in the container object. Container contents may also be deleted or reordered using the interface 206. More generally, in some embodiments entering data in the interface 206 for a container object 212 performs at least one of the following: adding data to the container object, deleting data from the container object, reordering data within the container object, modifying data in the container object.

Some embodiments include graphical programming object population user interface autogeneration code 202 residing in the memory 112. The code 202 is capable of automatically determining what fields are defined for the object type instance (by itself or by invoking a separate metadata analyzer 210), and is also capable of automatically generating the instance data population user interface 206 in the graphical programming environment 120.

Some embodiments include a workflow application 122 residing in the memory 112 and containing the instance data population user interface 206. In some cases, the workflow application 122 is a sequential workflow application. In some embodiments, the instance data population user interface 206 is in operable communication with, and serves as, a class initializer 218 for a class that is defined with the object type 124. In some, the user interface 206 is in operable communication with, and serves as, an object configurator 220 for an existing object which is defined with the object type.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment in which computing services are not owned but are provided on demand. For example, object types 124 may be on multiple devices/systems 102 in a networked cloud, UI autogeneration code 202 and metadata analyzer 210 may be stored on yet other devices within the cloud, and the generated data population user interface 206 may configure the display on yet other cloud device(s)/system(s) 102.

Processes

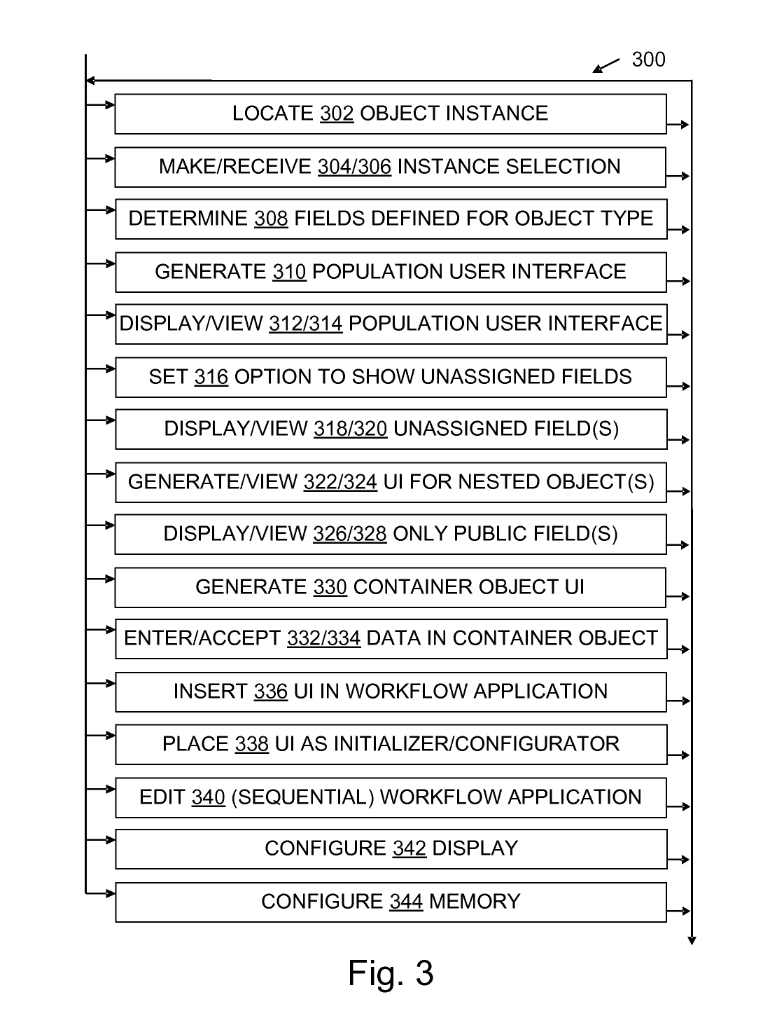

FIG. 3 illustrates some process embodiments in a flowchart 300. Processes shown in the Figures may be performed in some embodiments automatically, e.g., by a code 202—enhanced graphical programming environment 120 driven by replayed or simulated gestures 204 under control of a script or otherwise requiring little or no contemporaneous live user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During an instance locating step 302, a user (or an embodiment operating on behalf of a user) locates an object instance 126. Step 302 may be accomplished using a graphical user interface (GUI) and search facility in an IDE 140 or other development environment 120, or other mechanism which lists, displays, or otherwise locates a group of at least one (possibly multiple) instances containing a particular instance in question, for example.

During an instance selection making step 304, a user (or an embodiment operating on behalf of a user) makes a selection of a particular instance 126. Step 304 may be accomplished using mouse clicks or other familiar item selection mechanisms, for example.

During an instance selection receiving step 306, an embodiment receives a selection made 304 by a user. Step 306 may be accomplished using a GUI and pointers to a memory version of an instance, or other mechanisms, for example. Steps 304 and 306 correspond generally to each other, with selection making step 304 being from a user's perspective and selection receiving step 306 being from an implementation's perspective.

During a field(s) determining step 308, an embodiment determines what fields 128 are defined for an instance 126, and related aspects such as value(s) 136 currently assigned to field(s). Step 308 may be accomplished using a metadata analyzer 210 with operable access to intermediate representations, symbol tables, abstract syntax trees, and/or other mechanisms, such as mechanisms used in compilers and debuggers for determining fields and related aspects of objects, for example.

During a user interface generating step 310, an embodiment automatically generates a data population user interface 206, based on information determined 308 about fields 128 of a selected object instance 126. Step 310 may be accomplished using GUI generation mechanisms adapted for the specific context and specific results described herein, or other mechanisms, for example.

During a user interface displaying step 312, an embodiment displays an automatically generated 310 data population user interface 206, e.g., on a screen or in a printout, using familiar display mechanisms adapted for the specific context and specific results described herein.

During a user interface viewing step 314, a user views an automatically generated 310 data population user interface 206, e.g., on a display screen or in a printout. Steps 312 and 314 correspond generally to each other, with displaying step 312 being from an implementation's perspective and viewing step 314 being from a user's perspective.

During an unassigned option setting step 316, a user (or an embodiment operating on behalf of a user) sets a flag, checkbox, or other variable to indicate that unassigned fields 128 should be displayed 312 in the user interface 206. Step 316 may be accomplished using mouse clicks or other familiar selection mechanisms plus a bitflag, Boolean variable or other mechanism to contain the current setting of the option 222, for example. Although not expressly illustrated in the Figure, it will be understood that an equivalent aspect of such embodiments is an unassigned option clearing step which indicates that unassigned fields 128 should not be displayed 312 in the user interface 206. Some embodiments have a default setting (modifiable by the user) in which unassigned fields 128 are displayed 312, and some have a default setting in which unassigned fields 128 are not displayed 312.

During an unassigned fields displaying step 318, an embodiment displays at least one unassigned field 128 in an automatically generated 310 data population user interface 206, as part of interface displaying step 312.

During an unassigned fields viewing step 320, a user views at least one unassigned field 128 in an automatically generated 310 data population user interface 206, as part of interface viewing step 314. Steps 318 and 320 correspond generally to each other, with displaying step 318 being from an implementation's perspective and viewing step 320 being from a user's perspective.

During a nested object interface generating step 322, an embodiment generates at least one field 128 of a nested object 216 in a data population user interface 206, as part of interface generating step 310.

During nested object interface viewing step 324, a user views at least one field 128 of a nested object 216 in an automatically generated 310 data population user interface 206, as part of interface viewing step 314. Steps 322 and 324 correspond generally to each other, with generating step 322 being from an implementation's perspective and viewing step 324 being from a user's perspective.

During a public fields only displaying step 326, an embodiment displays only public field(s) 132 in an automatically generated 310 data population user interface 206, as part of interface displaying step 312.

During a public fields only viewing step 328, a user views only public field(s) 132 in an automatically generated 310 data population user interface 206, as part of interface viewing step 314. Steps 326 and 328 correspond generally to each other, with displaying step 326 being from an implementation's perspective and viewing step 328 being from a user's perspective.

During a container object interface generating step 330, an embodiment generates at least one field 128 of a container object 212 in a data population user interface 206, as part of interface generating step 310. More generally, it would be understood that in some embodiments container objects 212, nested objects 216, and other objects are each subject to interface 206 generating, interface 206 displaying, and interface 206 viewing steps, even though some of those steps are not expressly shown in FIG. 3 in their-most specific form.

During a data entering step 332, a user (or an embodiment operating on behalf of a user) enters data value(s) 136 to be assigned to field(s) 128 of an instance 126, by entering the value(s) in the user interface 206. In particular, a user may enter data values for a container object 212, but date may also be entered 332 for other kinds of objects. Step 332 may be accomplished using familiar GUI mechanisms adapted for the specific context and specific results described herein.

During a data accepting step 334, an embodiment data population user interface 206 accepts data value(s) 136 to be assigned to field(s) 128 of an instance 126. Steps 332 and 334 correspond generally to each other, with accepting step 334 being from an implementation's perspective and entering step 332 being from a user's perspective.

During an interface inserting step 336, a user (or an embodiment operating on behalf of a user) inserts a user interface 206 in an application 122, such as a sequential workflow application, another workflow application, or another application under development in the graphical programming environment 120. Step 336 may be accomplished using familiar GUI mechanisms, and data structures representing the application and the interface 206, adapted for the specific context and specific results described herein.

During an interface placing step 338, which may be part of inserting step 336, a user (or an embodiment operating on behalf of a user) places a user interface 206 in an application 122 as part or all of a class initializer 218 and/or object configurator 220.

During an application editing step 340, a user (or an embodiment operating on behalf of a user) edits an application 122 in a graphical programming environment 120. Steps such as the foregoing steps 302 through 338 may occur within, or in response to, editing step 340.

During a display configuring step 342, a user (or an embodiment operating on behalf of a user) configures a display 138 with an automatically generated 310 data population user interface 206, thus making possible the viewing of the interface 206.

During a memory configuring step 344, a memory medium 112 is configured by an automatically generated 310 data population user interface 206, by UI autogeneration code 202, or otherwise in connection with data population user interface generation as discussed herein.

The foregoing steps and their interrelationships are discussed in greater detail below, in connection with various embodiments.

From an implementation's point of view, some embodiments provide a process for utilizing an instance 126 of an object type 124 in a graphical programming environment 120. The instance has at least one field 128 defined by the object type; each field of the instance has a name 134 and is capable of being assigned a value 136 (by the user dynamically and/or by a compiler, e.g., as a constant or a variable). The process includes receiving 306 a selection that identifies the instance of the object type, automatically determining 308 what fields are defined for the object type instance, automatically generating 310 an instance data population user interface in the graphical programming environment, and displaying 312 at least the following in the user interface: the name of each field that is defined for the object type instance, and a currently assigned value for each field that currently has an assigned value.

In some embodiments, displaying 312 includes displaying 318 a field of the object type instance which has no currently assigned value together with a visual indication 224 that the field has no currently assigned value. In some, the displaying step displays only fields which have been defined as public fields 132.

In some embodiments, a field (denoted here as field F merely for convenient reference) of the instance 126 is an object with fields of its own. In such cases, the process may include automatically determining 308 what fields are defined for the field F object, and displaying 312 at least the following in the user interface: the name of each field that is defined for the field F object, and a currently assigned value for each field of the field F object that currently has an assigned value. Likewise, unassigned fields of the field F object may be displayed 318, and the display may show only public fields of the field F object.

In some embodiments, the instance 126 is a container object 212. In such cases, the process may include accepting 334 data into the container object through the instance data population user interface 206 without replacing prior value(s) which were present in the container object.

In some embodiments, the process includes inserting 336 the instance data population user interface into a workflow application 122 or other application which is being edited 340 in the graphical programming environment. In some, the process includes placing 338 the instance data population user interface 206 in an application under development, with the user interface being placed as at least one of the following: a class initializer 218 for a class that is defined with the object type 124, an object configurator 220 for an existing object which is defined with the object type.

From a user's point of view, some embodiments provide a process for populating objects with data. The process includes locating 302 an instance of an object type in a graphical programming environment, making 304 an instance selection gesture in the graphical programming environment to indicate selection of the instance, and viewing 314 in the graphical programming environment in response to the instance selection gesture an automatically generated instance data population user interface 206. The interface 206 displays at least the following: the name of each field that is defined for the object type instance, and a currently assigned value for each field that currently has an assigned value.

In some embodiments, the process includes setting 316 an option 222 to show unassigned arguments. In such cases, the viewing step may include viewing 320 a field of the object type instance which has no currently assigned value together with viewing a visual indication 224 that the field has no currently assigned value.

In some embodiments, a field (again denoted F merely for convenience) of the instance is an object with fields of its own, and the viewing step includes viewing 324 the name of each field that is defined for the field F object, and viewing 324 a currently assigned value for each field of the field F object that currently has an assigned value.

In some embodiments, the instance is a container object 212, and the process includes entering 332 data into the container object through the instance data population user interface 206 without thereby replacing prior value(s) which were present in the container object.

Some embodiments include editing 340 a sequential workflow application in the graphical programming environment, e.g., by inserting 336 the instance data population user interface into the sequential workflow application.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as UI autogeneration code 202, data population interfaces 206 generated by code 202, and show unassigned options 222 and indicators 224, in the form of data 118 and instructions 116, read from a removable medium 114 and/or another source such as a network connection, to form a configured medium. The configured medium 112 is capable of causing a computer system to perform process steps for transforming data through UI autogeneration as disclosed herein. FIGS. 1 through 3 thus help illustrate configured storage media embodiments and process embodiments, as well as system and process embodiments. In particular, any of the process steps illustrated in FIG. 3, or otherwise taught herein, may be used to help configure a storage medium to form a configured medium embodiment.

### Additional Examples

Additional details and design considerations are provided below. As with the other examples herein, the features described may be used individually and/or in combination, or not at all, in a given embodiment.

Those of skill will understand that implementation details may pertain to specific code, such as specific screen layouts, specific applications, and specific programming languages, for example, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

The following discussion is derived from prototype documentation for a program implemented by Microsoft® Corporation. Aspects of the prototype program and/or documentation are consistent with or otherwise illustrate aspects of the embodiments described herein. However, it will be understood that prototype documentation and/or implementation choices do not necessarily constrain the scope of such embodiments, and likewise that the prototype and/or its documentation may well contain features that lie outside the scope of such embodiments. It will also be understood that the discussion below is provided in part as an aid to readers who are not necessarily of ordinary skill in the art, and thus may contain and/or omit details whose recitation below is not strictly required to support the present disclosure.

As a preliminary example, suppose a developer is working with code that has a class like this:

```
public class Customer
{
  public int ID { get; set; }
  public string Name { get; set; }
  public Customer Buddy { get; set; }
}
```

In a graphical programming environment which lacks enhancing embodiments presented herein, the developer may well add many UI elements to the screen to do even a simple task. For example, a lengthy list of operations may be used merely to create a Customer called John and set his Buddy to Mary. As a result, the display may become cluttered with a sequence of graphical elements which present respective textual labels or contents as follows:

### Sequence

A ← B Assign c = New Customer( )
A ← B Assign c.ID = 123
A ← B Assign c.Name = “John”
A ← B Assign c.Buddy = New Customer( )
A ← B Assign c.Buddy.ID = 456
A ← B Assign c.Buddy.Name = “Mary”

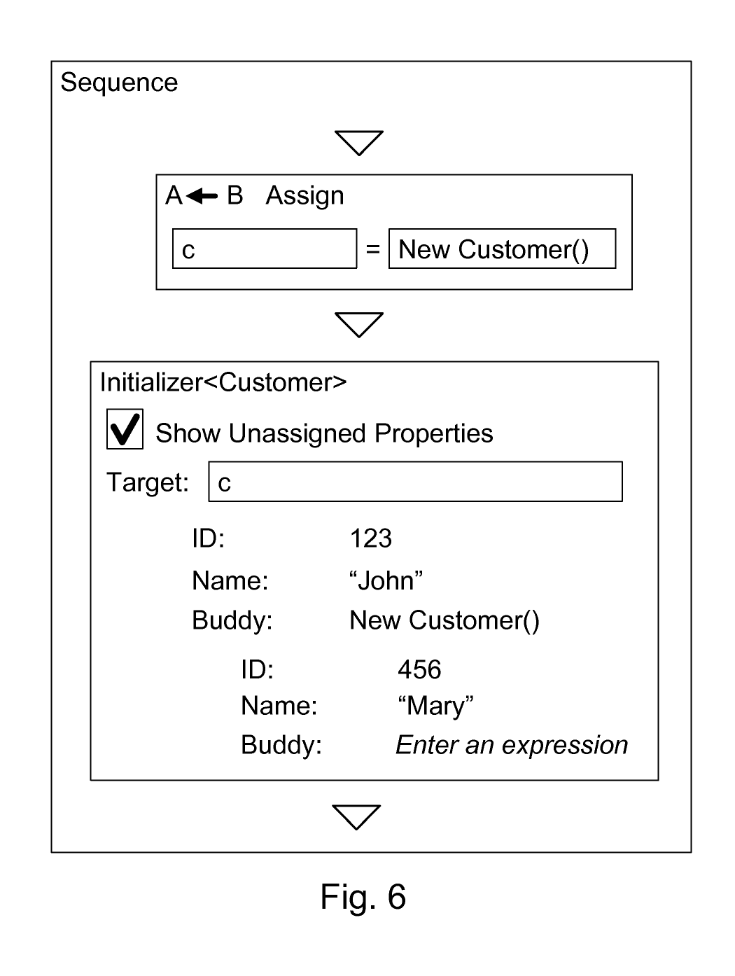

By contrast, the screenshot in FIG. 6 demonstrates how the same task looks in some embodiments. The screen is much cleaner, and the developer is not called on to memorize which properties are defined in the Customer class.

In some implementations, an Initializer Activity provides a way for developers to declaratively initialize (assign multiple properties) a complex data type in Microsoft® Windows Workflow Foundation (WF) or other contexts. Such implementations and/or related embodiments provide one or more of the following features: Allow developers to initialize a variable/argument with multiple settable properties with one activity; Allow developers to set multiple properties in a variable/argument with one activity; Allow developers to set multiple properties for an already created object instance; Provide a designer (interface 206) to edit initialization/multi assign logic without excessive drag-drop or button/menu click; Provide an Initializer to handle properties of simple type; Allow developers to define initializers in nested way (in both code and designer); Allow developers change the type for designers after a type is selected; Allow developers to write custom initialization logic for specific types.

As an example scenario, suppose developer E is building an application which integrates an Enterprise Resource Planning (ERP) system and a Customer Relationship Management (CRM) system from different venders. Assume the two systems use different types to represent a customer. The ERP system uses this format:

```
public class Address
{
    public string StreetAddress { get; set; }
    public string City { get; set; }
    public string Province { get; set; }
    public string PostalCode { get; set; }
}
public class ErpCustomer
{
    public string Name { get; set; }
    public Address Address { get; set; }
}
```

The CRM system uses this format:

```
public class CrmCustomer
{
    public string FirstName { get; set; }
    public string LastName { get; set; }
    public string AddressFirstLine { get; set; }
    public string AddressSecondLine { get; set; }
    public string City { get; set; }
    public string State { get; set; }
    public string ZipCode { get; set; }
}
```

In the workflow, developer E reads customer data from the CRM system as objects of CrmCustomer and wishes to put them into the ERP system as objects of ErpCustomer. The two types are not the same, but could be converted with this set of rules:
CrmCustomer.LastName +“,”+CrmCustomer.FirstName
->ErpCustomer.Name
CrmCustomer.AdddressSecondLine+“,”+
CrmCustomer.AddressFirstLine ->
ErpCustomer.Address.StreetAddress
CrmCustomer.City
->ErpCustomer.Address.City
CrmCustomer.State
->ErpCustomer.Address.Province
CrmCustomer.ZipCode
->ErpCustomer.Address.PostalCode

Developer E does not want to implement this logic using five Assign Activities because it's tedious and hard to read in a designer. E does not want to write code to do this either. E wants to use one program construct to do this conversation declaratively in the designer, where E could easily edit each property conversation rule separately.

Other motivating scenarios may also be provided, such as complex data contract initialization for invocation of a web service using Microsoft®Windows Communication Foundation or the like; complex data mapping when reading some data out of a database table; initializing a Dictionary of arguments when designing a Microsoft® Windows PowerShell™ Activity; exposing a complex data type as arguments when writing an HTTP Activity; writing customized initialization logic; and so on (marks of Microsoft Corporation).

Some implementations provide an Activity API such as the following:

### Initializer Activity

```
public class Initializer<T> : NativeActivity<T>
{
    public InArgument<T> Target
    {
        get;
        set;
    }
    public IDictionary<string, InArgument> PropertyValues
    {
        get;
    }
    public IDictionary<string, ActivityDelegate>
PropertyInitializers
    {
        get;
    }
}
```

With regard to the foregoing API, the following is to be noted.

Target: the object to be initialized. If this is null, Initializer will try to create one with public default constructor. If this argument is not set (Expression==null), and type T does not have a public default constructor and this argument is not set, Initializer will raise a validation error; if the argument is evaluated to null and type T does not have a public validation error, Initializer will throw an exception at runtime.

PropertyValues: a dictionary of string to InArgument. Initializer will set the value of the InArgument to the property with the name. If type T does not have a public settable property with the name, Initializer<T> will raise a validation error.

PropertyInitializers: a dictionary of string to ActivityDelegate. This is used to initialize properties which are not settable, but could be initialized. For example, very often Collection property could not be set, but one can get the collection and fill it with data. Initializer will pass the property specified by the name to the ActivityDelegate for initialization. If type T does not have a public property with the name, Initializer<T> will raise a validation error.

In some implementations, the following type(s) are not allowed as the type parameter of Initializer (the “T” in Initializer<T>): Enum types, Primitive types. Initializer<T>.PropertyInitializers cannot be used to initialize properties of Primitive types.

In some implementations, the following are provided:

```
CollectionInitiallzer Activity
public class CollectionInitializer<TCollection, TValue> :
CodeActivity<TCollection>
    where TCollection : ICollection<TValue>
{
    public InArgument<TCollection> Target
    {
      get;
      set;
    }
    public Collection<InArgument<TValue>> InitialData
    {
      get;
    }
}
DictionaryInitializer Activity
public class DictionaryInitializer<TDict, TKey, TValue> :
CodeActivity<TDict>
    where TDict : IDictionary<TKey, TValue>
{
  public InArgument<TDict> Target
  {
    get;
    set;
  }
  public Collection<InArgument<KeyValuePair<TKey,
TValue>>> InitialData
  {
    get;
  }
}
```

As further illustration, here is a sample XAML for an Initializer instance:

```
<?xml version=“1.0” encoding=“utf-8”?>
<Initializer x:TypeArguments=“c:ErpCustomer”
        Target=“{x:Null}”
        xmlns=“clr-
namespace:Initializer;assembly=Initializer”
        xmlns:c=“clr-
namespace:ConsoleTest;assembly=ConsoleTest”
xmlns:p=“http://schemas.microsoft.com/netfx/2009/xaml/activities”
xmlns:x=“http://schemas.microsoft.com/winfx/2006/xaml”>
  <Initializer.PropertyValues>
    <p:InArgument x:TypeArguments=“x:String” x:Key=“Name”>
      [crmCustomer.LastName &amp; “, ” &amp;
crmCustomer.FirstName]
    </p:InArgument>
    <p:InArgument x:TypeArguments=“c:Address”
x:Key=“Address”>
      <Initializer x:TypeArguments=“c:Address”
Target=“{x:Null}”>
        <Initializer.PropertyValues>
          <p:InArgument x:TypeArguments=“x:String”
x:Key=“StreetAddress”>
            [crmCustomer.AddressSecondLine &amp; “, ” &amp;
crmCustomer.AddressFirstLine]
          </p:InArgument>
          <p:InArgument x:TypeArguments=“x:String”
x:Key=“City”>
            [crmCustomer.City]
          </p:InArgument>
          <p:InArgument x:TypeArguments=“x:String”
x:Key=“Province”>
            [crmCustomer.State]
          </p:InArgument>
          <p:InArgument x:TypeArguments=“x:String”
x:Key=“PostalCode”>
            [crmCustomer.ZipCode]
          </p:InArgument>
        </Initializer.PropertyValues>
      </Initializer>
    </p:InArgument>
  </Initializer.PropertyValues>
</Initializer>
```

As to a Designer, first consider Simple Property setters. When an Initializer Activity is dragged from toolbox to designer surface, a dialog pops up to ask for the type which it will initialize on, and the developer makes 304 a selection. Assume the developer selected this Order type:

```
public class Customer
{
    public string FirstName { get; set; }
    public string LastName { get; set; }
    public string StreetAddress { get; set; }
    public string City { get; set; }
    public string State { get; set; }
    public string ZipCode { get; set; }
}
public class Order
{
    public int Id { get; set; }
    public string Sku { get; set; }
    public int Quantity { get; set; }
    public string PromotionCode { get; set; }
    public double UnitPrice { get; set; }
    public Customer Customer { get; set; }
}
```

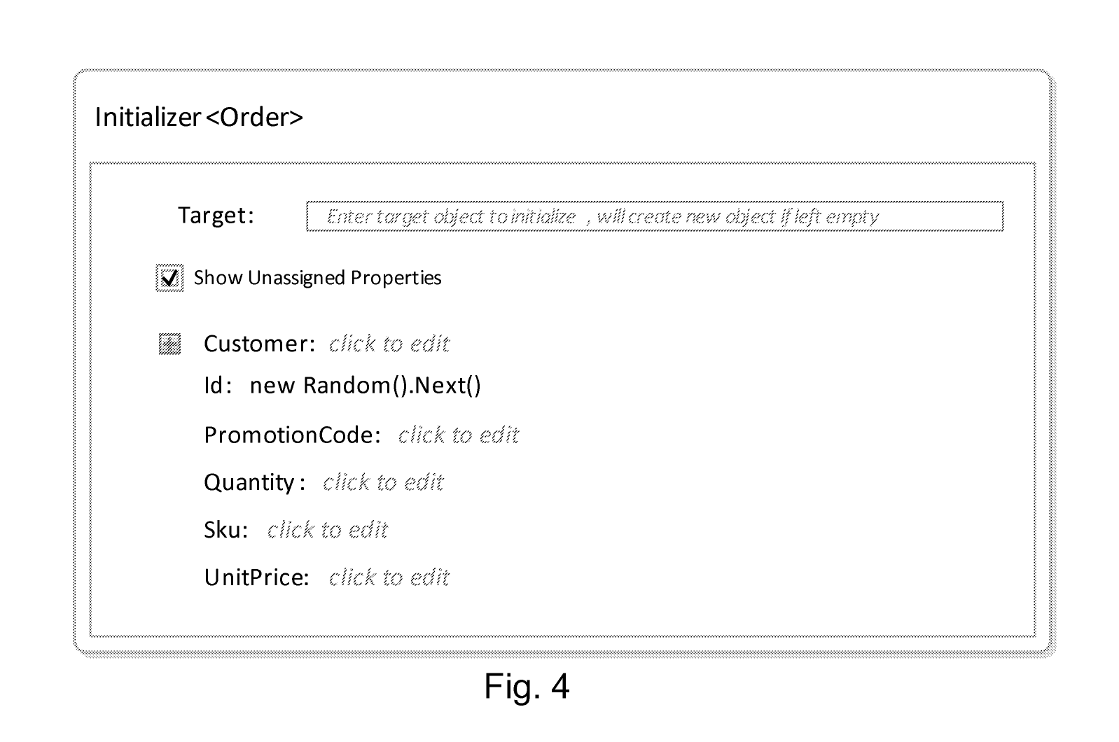

Once a type selection is received 306, a designer shows up; the designer includes a data population user interface 206. In this example, the designer looks like FIG. 4, except that initially no value has been entered 332 for the Id field.

In some implementations; the first line displayed in the designer is the object to initialize; if left blank, the Activity will create an object using default constructor and set it to Result argument. The main body of the designer is a tree view. Tree nodes at the first level are all public settable properties (fields 128) of the selected type 124. Every node is in “<Property name>: <Property value expression>” format. If a property hasn't been set any value, a hint text “click to edit” indicator 224 will be displayed next to its property name 134. If the developer E wants to set a value for any property, E could click the tree node. The hint text “click to edit” will be replaced by an ExpressionTextBox for E to enter an expression for this property's value. After the tree node loses focus, the ExpressionTextBox will be gone, but the expression text will show up next to the property name, as illustrated in FIG. 4.

Some implementations provide a MultiAssign<T> like the Initializer<T>, except that it does not inherit from Activity<T>, meaning that it will not have a Result OutArgument. The Target argument will become a required argument, since it does not make sense to multi-assign values to a null object.

In some implementations, the developer E could use a “Hide unfilled properties” checkbox (also called “show unassigned properties” in one implementation) (clear option 222) to avoid overcrowding the screen with UI elements. Once E does that, all properties whose argument hasn't been set will be hidden away from the tree view, and an ellipsis (for example) will appear under the tree view to indicate there are hidden properties.

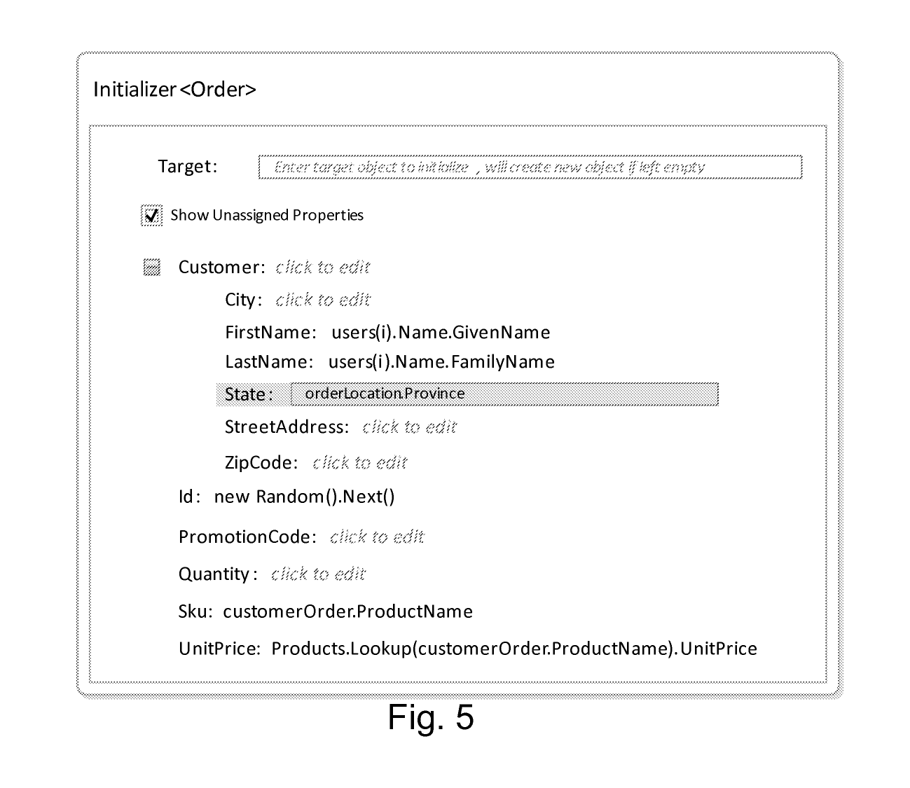

Some implementations provide a nested initializer for complex properties. The tree view in the lower part (for a nested object 216) is dynamically generated based on the nest object's type 124. Each settable property has one tree view item. The item has an expression text box by default, so developers could enter 332 an expression for a value to set for that property. If a property is a complex type, the tree item could be expanded to have all its properties listed as child nodes. Similarly, any child node could be clicked to edit its expression, as illustrated in FIG. 5, in which Customer is a nested object 216 whose own properly is being edited. The “Hide unfilled properties” checkbox may apply to child properties as well. Properties at any supported finite nesting level could be expanded and the tree could go any such level deep.

In some implementations, a collection property initializer is provided. Some properties are not settable (no setter, only getter), but check whether the object is of type ICollection< >. Those properties can be specially handled. An “Add new element” button will appear beside a tree node for that property, when clicked, a new element will be added under that tree node. Developers could write down expressions for new elements in the sub node. A developer could reorder elements in collection child nodes by drag and drop using a mouse. A developer could also delete an element by pressing the “DEL” key or using a “delete” context menu item.

Some implementations provide a Dictionary property initializer. Dictionary implements IEnumerable and has “Add” and “Delete” methods, so it can be specially handled as discussed herein. Dictionary's element editor may see two expression text boxes, one for a key expression and one for a value expression. The Initializer Designer saves the following information in a view state variable: The “Show Unassigned Arguments” flag value; The IsExpanded flag of the tree nodes (only if the tree node has descendants).

In some implementations, an Activity will generate validation errors for these cases: The type parameter (the “T” in Initializer<T>) is an invalid one; Target argument is not set (Expression==null), but the type does not have a public default constructor (include the cases where T is an interface and abstract class); T is a value type but Result argument is not bound; PropertyValues and PropertyInitializers have duplicate property names; For any entry in PropertyValues, there is no public settable property with the name and type (determined by Argument.ArgumentType); For any entry in PropertyInitializers, there is no public gettable property with the name; For any entry in PropertyInitializers, the property to be initialized is not of a valid type.

In some implementations, Initializer will use a predetermined order to initialize all properties: it will first run all PropertyValue setters based on order of the collection; then run all PropertyInitializers based on order of the collection. Initializer designer will always pre-populate PropertyValues collection (with empty argument) based on reflection order. It will do the same for PropertyInitializers.

In some implementations, Initializer<T> resolves properties based on type T, to provide Microsoft® IntelliSense® help (or other help) at workflow design time; this involves knowing type information at design time (marks of Microsoft Corporation). Accordingly, the following hold: Even if Target could be resolved to an instance of T's subtype, the subtype's properties won't be recognized in Initializer<T>.PropertyValues; Even if T implements ICustomTypeDescriptor, developers could not access any dynamic properties added by ICustomTypeDescriptor; If T explicitly implements an interface property like “int IFoo.Blah {get; set;}”, this property could not be accessed using Initializer<T>. It could only be accessed by Initializer<IFoo>. There are some cases where property access might be ambiguous, like property shadowing or same property naming come from multiple interfaces. In general, the property resolution rule is same as in the C# language. In a C# expression “Foo.Prop”, whatever the property “Prop” is resolved to, the Initializer property access “FooInit[“Prop”]” is resolved to the same property.

In some implementations, the Initializer addresses two kinds of case scenarios. One is Initialization cases: initialize properties when an object is being created. In this case, developers could leave Target argument empty and assign Result argument to a variable. This may be equivalent to C# initializer syntax. The other is Property assign cases: set properties for an existing object. In this case, a developer could bind Target argument to a workflow variable and discard the Result. This provides a shorter approach than multiple assign statements.

It will be understood that the technology discussed here under the name “Initializer” may be present under other names. Other terminology that might be used includes, for example, “MultiAssign”, “TransformObject”, “CreateReplica”, “ObjectFiller”, “ObjectCharger”, “CreateObject”, “InitializeObject”, and others.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and the are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computer-readable non-transitory storage medium configured with data and with instructions that when executed by at least one processor causes the processor(s) to perform a process for utilizing an instance of an object type in a graphical programming environment, the instance having at least one field defined by the object type, each field of the instance having a name and capable of being assigned a value, the process comprising the steps of:
receiving a selection that identifies the instance of the object type;
automatically determining what fields are defined for the object type instance;
automatically generating an instance data population user interface in the graphical programming environment; and
displaying at least the following in the user interface: the name of each field that is defined for the object type instance, and a currently assigned value for each field that currently has an assigned value.

2. The configured medium of claim 1, wherein the displaying step comprises displaying a field of the object type instance which has no currently assigned value together with a visual indication that the field has no currently assigned value.

3. The configured medium of claim 1, wherein a field F of the instance is an object with fields of its own, and the process comprises the steps of:
automatically determining what fields are defined for the field F object; and
displaying at least the following in the user interface: the name of each field that is defined for the field F object, and a currently assigned value for each field of the field F object that currently has an assigned value.

4. The configured medium of claim 1, wherein the displaying step displays only fields which have been defined as public.

5. The configured medium of claim 1, wherein the instance is a container object, and the process further comprises accepting data into the container object through the instance data population user interface without replacing prior value(s) which were present in the container object.

6. The configured medium of claim 1, wherein the process further comprises inserting the instance data population user interface into a workflow application which is being edited in the graphical programming environment.

7. The configured medium of claim 1, wherein the process further comprises placing the instance data population user interface in an application under development, the user interface being placed as at least one of the following:
a class initializer for a class that is defined with the object type;
an object configurator for an existing object which is defined with the object type.

8. A process for populating objects with data, the process comprising the steps of:
locating an instance of an object type in a graphical programming environment, the instance having multiple fields defined by the object type, each field of the instance having a name and capable of being assigned a value, at least one field of the instance currently having an assigned value;
making an instance selection gesture in the graphical programming environment, namely, a gesture which indicates selection of the instance; and
viewing in the graphical programming environment in response to the instance selection gesture an automatically generated instance data population user interface which displays at least the following: the name of each field that is defined for the object type instance, and a currently assigned value for each field that currently has an assigned value.

9. The process of claim 8, wherein the process further comprises setting an option to show unassigned arguments, and wherein the viewing step comprises viewing a field of the object type instance which has no currently assigned value together with a visual indication that the field has no currently assigned value.

10. The process of claim 8, wherein a field F of the instance is an object with fields of its own, and the viewing step comprises viewing the name of each field that is defined for the field F object, and viewing a currently assigned value for each field of the field F object that currently has an assigned value.

11. The process of claim 8, wherein the instance is a container object, and the process further comprises entering data into the container object through the instance data population user interface, thereby performing at least one of the following: adding data to the container object, deleting data from the container object, reordering data within the container object, modifying data in the container object.

12. The process of claim 8, wherein the process further comprises editing a sequential workflow application in the graphical programming environment by inserting the instance data population user interface into the sequential workflow application.

13. A computer system comprising:
a logical processor;
a memory in operable communication with the logical processor;
a graphical programming environment residing in the memory and having an instance of an object type in a graphical programming environment, the instance having at least one field defined by the object type, each field of the instance having a name and capable of being assigned a value;
a display; and
an automatically generated instance data population user interface configuring the display with at least the following: the name of each field that is defined for the object type instance, and a currently assigned value for each field that currently has an assigned value.

14. The system of claim 13, wherein the display is further configured by a field of the object type instance which has no currently assigned value together with a visual indication that the field has no currently assigned value.

15. The system of claim 13, wherein a field F of the instance is an object with fields of its own, and wherein the display is configured by the name of at least two fields that are defined for the field F object and also configured by a currently assigned value of at least one field of the field F object.

16. The system of claim 13, wherein the instance has at least one field that is defined as read-only with regard to access from outside the object, and the automatically generated instance data population user interface configuring the display does not accept data for assignment to that read-only field.

17. The system of claim 13, wherein the instance is a container object, and the system further comprises both (i) first data which appears in the container without being present in the instance data population user interface, and (ii) later data which appears in the container and also appeared in the instance data population user interface, whereby the later data is entered into the container object through the user interface without replacing the first data which was previously present in the container object.

18. The system of claim 13, further comprising graphical programming object population user interface autogeneration code residing in the memory and capable of automatically determining what fields are defined for the object type instance and automatically generating the instance data population user interface in the graphical programming environment.

19. The system of claim 13, further comprising a workflow application residing in the memory and containing the instance data population user interface.

20. The system of claim 13, further comprising at least one of the following in operable communication with the instance data population user interface: a class initializer for a class that is defined with the object type, an object configurator for an existing object which is defined with the object type.
